(19) United States
(12) Patent Application Publication
(10) Pub. No.: US 2025/0203027 A1
(43) Pub. Date: Jun. 19, 2025

(54) Document Reading Device and Method

(71) Applicant: CUSTOM S.P.A., Fontevivo (PR) (IT)

(72) Inventor: Alberto Campanini, Fidenza (PR) (IT)

(21) Appl. No.: 18/847,319

(22) PCT Filed: Mar. 22, 2023
(86) PCT No.: PCT/IB2023/052801

§ 371 Date: Sep. 16, 2024

(30) Foreign Application Priority Data
Mar. 24, 2022 (IT) 102022000005900

(51) Int. Cl. H04N 1/00; H04N 1/195

(52) U.S. Cl. CPC H04N 1/00801; H04N 1/00702; H04N 1/00726; H04N 1/00734; H04N 1/00835; H04N 1/19594

(57) ABSTRACT

A device and a method are disclosed for reading a document such as, for example, a card, or a ticket or a sales receipt or a receipt etc, placed by a user in front of the reading device, in which the document is positioned in a reading zone in which it is read by one or more image sensors and a further detection of the document positioned in the reading zone is performed by remote detection sensor based on the time elapsing between the emission of a pulse and the reception of a return signal and/or based on the intensity of the return signal received, in which the further detection is used for verifying and/or correcting the reading performed by said one or more image sensors.

### TECHNICAL BACKGROUND

The invention relates to a document reading device and method, in particular for reading a document presented by a customer (for example by holding the document in the hand) in front of the reading device.

Specifically, but not exclusively, the invention can be used to read tickets, cash receipts, cards, receipts, etc.

In particular, the invention can be used to read the position of a mark, or cross, or tick, or hole, etc, on a document, for example a document filled in for a lottery or similar game, although it could be used for other purposes like, for example, reading a code (for example a bar, linear or two-dimensional code) printed on the document and/or for reading a document with optical character recognition (OCR).

The prior art comprises scanning devices for lottery tickets in which the ticket, held in the hand of a user or left on a support, is presented to one or two image sensors that read the contents of the ticket. In some known devices, the image sensors are provided with means, for example of infrared or ultrasound type, to focus the image.

The patent publication US 2019/0370988 A1 shows a reading device according to the preamble of the claim 1.

One of the drawbacks of the prior art is the risk of failure to read, or erroneous or incomplete reading of the ticket owing to aberrations of various type, in general provided by the fact that the ticket can be folded, deformed, curled, in shade, or be presented in an inappropriate manner in front of the sensor/s.

Devices of known type for scanning lottery tickets are in general capable of recognizing, reading and interpreting correctly the ticket even if the ticket is held in a hand and is presented to the reader with a certain tilt in a “front-backwards” direction, whereas a presentation with a tilt in a “right-left” direction, or with a mixed or anyway complex tilt can more often lead to reading irregularities. Other irregular situations can be the loss of planarity of the ticket, the presence of folds and/or curvatures and/or creases and/or ripples, the lack of a piece of a ticket that has torn, the interference of a finger of the user in the reading, etc.

### SUMMARY

One object of the invention is to make a device and/or a method that is able to overcome the aforesaid limits and drawbacks of the prior art.

One object is to provide a reading device and/or method that are alternative to those of the prior art.

One advantage is to permit a correct reading of a document even when the document is placed by a user inappropriately in front of the reading device and/or when there are defects or irregularities or alterations in the document and/or in the surrounding environment.

One advantage is to make available a device and/or a method that is able to recognize an irregular reading situation—for example if the document to be read, held in the hand of a user or resting on a support, is shown with a “right-left” tilt direction and/or in a “front-back” tilt direction, and/or is shown deformed with folds and/or curvatures and/or tears and/or wrinkles and/or crumpling and/or ripples, and/or is placed with a finger of the user that interferes with the reading—and to further make the appropriate reading corrections.

One advantage is to provide a document reading device that is constructionally simple and cheap and is of practical and immediate use.

These objects and advantages, and still others, are achieved by a device and/or by a method according to one or more of the claims set out below.

In one embodiment, a reading device comprises a reading zone where a user can position a document to be read (possibly also by holding the document in the hand), one or more image sensors for reading the document positioned in the reading zone, and remote detection sensor that performs a further detection of the document positioned in the reading zone, in which the further detection can be used to check and/or correct the reading performed by the aforesaid one or more image sensors. This further detection can be configured, in particular, in such a manner as to detect the actual conformation of the document, to determine possible modifications with respect to the normal conformation of the document (in general flat).

This further detection can be performed, in particular, based on the time elapsing between the emission of a pulse and the reception of a return signal and/or based on the intensity of the return signal received. The remote detection sensor can comprise, in particular, at least one LiDaR sensor.

The reading device can comprise, in particular, electronic controller configured to correct a reading performed by the aforesaid one or more image sensors based on signals received from the remote detection sensor that has performed the aforesaid further detection.

### BRIEF DESCRIPTION OF THE DRAWINGS

The invention can be better understood and implemented with reference to the attached drawings that illustrate one embodiment by way of non-limiting example, in which:

FIG. 1 is a scheme in a vertical elevation of one embodiment of a document reading device according to the present invention;

FIG. 2 is a schematic partial top plan view of the document reading device of FIG. 1;

FIG. 3 is a schematic vertical elevation view of the reading zone of the remote detection sensor of the device of FIG. 1;

FIG. 4 is a schematic top plan view of the reading zone of the remote detection sensor of the device of FIG. 1.

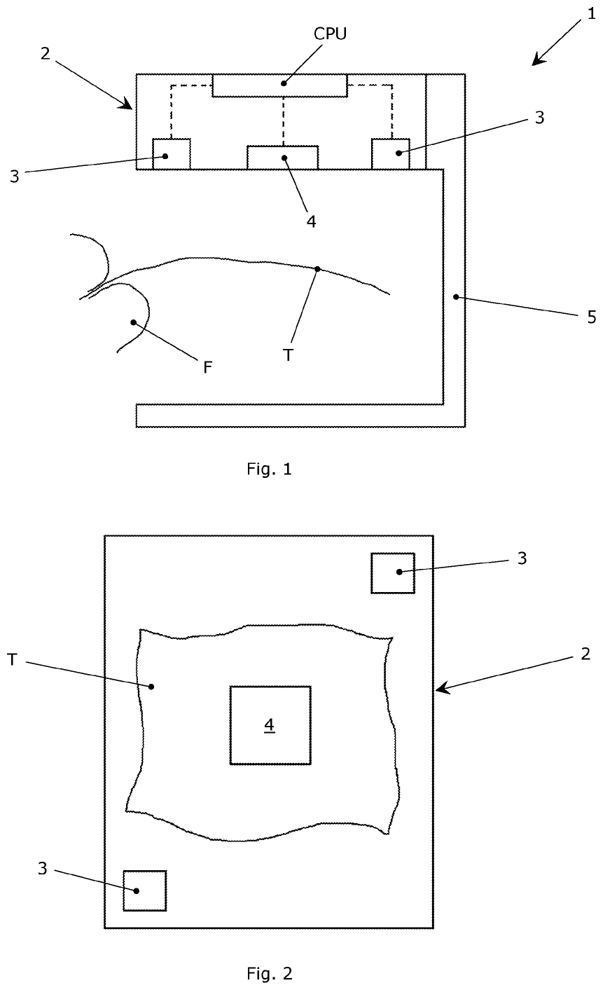

### DETAILED DESCRIPTION

With reference to the aforesaid figures, 1 denotes overall a reading device that can be used, in particular, to read a document placed in front of the reading device by a user, where the document could be held in the hand by the user or anyway positioned on a rest surface in a reading zone.

The reading device 1 can be used, in particular, to read tickets, cash receipts, cards, receipts, etc. The reading device 1 can be used, in particular, to read a lottery or similar gaming ticket, filled in with one or more marks, crosses, ticks, holes, etc. The reading device 1 can be applied, for example, to read a document with optical character recognition (OCR) and/or to scan lottery tickets and/or payment receipts.

The reading device 1 can comprise, in particular, a scanning module 2. The scanning module 2 can comprise, in particular, a box-shaped casing or support structure. The reading device 1 can comprise, in particular, a reading zone situated near the scanning module 2 (for example below the scanning module 2) and configured to enable a user to position a document T to be read by holding the document in one hand or leaving the document T to be read in a reading position on a rest surface in the reading zone. The scanning module 2 can be, in particular, carried by a support 5 that can be in turn configured, in particular, so that the scanning module 2 is raised with respect to the reading zone.

The reading device 1 can comprise, in particular, one or more (for example two, or three, or four, or more than four) image sensors 3, in particular arranged on the scanning module 2, and configured to read and/or scan the document T positioned in the reading zone. The image sensors 3 can be used, in particular, to read at least one feature of the document, like, in particular, the position of one or more marks, crosses, ticks, holes, etc, by which a compilation of the document T was conducted (for example a lottery card). The reading device 1 can comprise, in particular, at least two image sensors 3 arranged at a distance from each other, in particular arranged on the scanning module 2, each configured to read and/or scanning the document T positioned in the reading zone.

The image sensors 3 can comprise, in particular, the sensors normally used in a device for scanning lottery tickets or sales receipts. The image sensors 3 can comprise, in particular, one or more (for example two, or three, or four) CCD sensors and/or one or more (for example two, or three, or four) active pixel sensors (for example CMOS sensors).

The reading device 1 can comprise, in particular, remote detection sensor 4 configured to detect the document T positioned in the reading zone. The remote detection sensor 4 can be configured, in particular, to detect the document T based on the time elapsed between the emission of a pulse and the reception of a return signal. The remote detection sensor 4 can be configured, in particular, to detect an actual three-dimensional geometric conformation of the document T in space, in particular to determine possible differences in the conformation of the document with respect to the normal conformation (generally flat) that the whole and well-preserved document should have.

The remote detection sensor 4 can be configured, in particular, to detect whether the document is presented deformed with folds and/or curvatures and/or tears and/or wrinkles and/or crumpling and/or ripples, and/or to detect whether the document is shown with a finger of the user that interferes with the reading.

The remote detection sensor 4 can comprise, in particular, sensor of optical type. The remote detection sensor 4 can be configured, in particular, to emit a pulse of laser and/or infrared and/or ultrasound type. The remote detection sensor 4 can comprise, in particular (as in the specific embodiment), at least one LiDaR sensor.

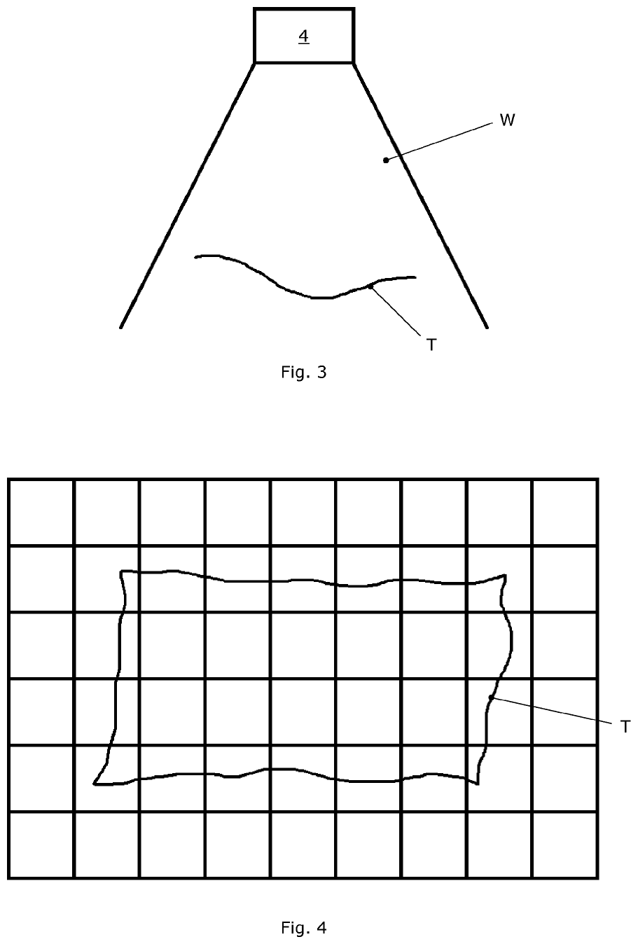

The remote detection sensor 4 can be configured, in particular, to generate a space W that is suitable for reading the document T (see FIG. 3). In the specific embodiment, the LiDaR sensor is configured to perform space mapping by dividing the reading zone of the document into a set of smaller regions arranged in a matrix (see FIG. 4) so as to obtain specific information on the document at each region. The information that is thus obtained can be used to recognize possible aberrations in the document and thus correct the reading of the document image performed by the image sensors 3. The LiDaR sensor can perform mapping of regions of the entire document so as to detect information, in particular, relating to the tilt and/or to the curvature of the document and/or relating to the geometry of the document and/or relating to the presence or absence of objects extraneous to the document (such as, for example, a finger F of the user who holds the document T in the hand and which could interfere with the reading).

The remote detection sensor 4 can comprise, in particular, at least one emission source of a radiation beam and a plurality of receivers of a return signal of the radiation beam. The remote detection sensor 4 can comprise, in particular, at least one laser source for emitting a coherent light beam and a plurality of receivers of a return signal of the coherent light beam. The aforesaid plurality of receivers can comprise, in particular, a matrix of receivers (for example a matrix of M×N sensors, with M≥2 and N≥2, like for example M=2, 3, 4, 5, 6, 7, 8, or 9 and N=2, 3, 4, 5, 6, 7, 8, or 9, although it is possible to use a different number of sensors, for example M≥10 and N≥10).

The remote detection sensor 4 can be configured, in particular, to detect information on the document positioned in the reading zone based on at least one intensity of the return signal received and/or based on the flight time of the emitted and received signal.

It is possible, in particular, to detect information, by the remote detection sensor 4, relating to the tilt and/or to the curvature and/or to other geometric features of the document, based on at least one intensity of the return signal received and/or based on the flight time. It is possible, in particular, to detect information relating to the geometry of the document based on at least one intensity of the return signal received and/or based on the flight time. It is possible, in particular, to detect information relating to the presence or absence of objects extraneous to the document (like, for example, a finger F of the user that holds in the hand the document T and which could interfere with the reading) based on at least one intensity of the return signal received and/or based on the flight time.

The remote detection sensor 4 can comprise, in particular, two or more receivers of the return signal arranged in different positions from one another.

The reading device 1 can comprise, in particular, electronic controller CPU connected to the aforesaid one or more image sensors 3 and/or connected to the aforesaid remote detection sensor 4 (one or more LiDaR sensors). The electronic controller CPU can be configured, in particular, to check and/or correct the reading performed by the aforesaid one or more image sensors 3 based on the detection performed by the aforesaid remote detection sensor 4.

The electronic controller CPU can be configured, in particular, to detect the presence of irregularities based on the detection performed by the aforesaid remote detection sensor 4 and thus verify whether the reading performed by the aforesaid one or more image sensors 3 is suitable and/or acceptable and/or possibly susceptible to correction and acceptable following this correction.

The operation of the reading device 1 can implement a reading method that can comprise, in particular, the step of positioning a document T in a reading zone. The reading method can comprise, in particular, the step of reading the document T positioned in the reading zone by one or more image sensors 3.

The reading method can comprise, in particular, the step of detecting the document T positioned in the reading zone by remote detection sensor 4, for example based on the time elapsing between the emission of a pulse and the reception of a return signal.

The aforesaid step of detecting the document T can comprise, in particular, the step of detecting an actual geometric conformation of at least one part of the document, for example to determine possible modifications with respect to the normal conformation (in general flat) of the whole and well-preserved document.

The reading method can comprise, in particular, the step of verifying and/or correcting the reading performed by the aforesaid one or more image sensors 3 based on the detection performed by the aforesaid remote detection sensor 4.

In these specific embodiments the remote detection sensor 4 (or remote sensing sensor) comprises sensors of optical type, for example sensors with laser pulses, in particular LiDaR (i.e. “Light Detection and Ranging”) sensors, although it is possible to use sensors of another type (for example sensors with radio wave and/or infrared and/or ultrasound pulses).

In particular, the remote detection sensor 4 can comprise a laser source for emitting a coherent light beam on a determined wavelength and a plurality of receivers (for example, as said, a matrix of M×N receivers). The remote detection sensor 4 can detect information on the document positioned in the reading zone based on the reception time of the return signal received from the aforesaid two or more receivers of the return signal and/or based on the intensity of the return signal received from the aforesaid two or more receivers of the return signal. As said, the aforesaid two or more receivers of the return signal can be arranged, in particular, in different positions from one another.

The reading device 1 can comprise, in particular, a user interface (for example comprising a screen) connected to the electronic controller CPU. The electronic controller CPU can be configured, in particular, to send signals to the aforesaid user interface on the basis of the detection performed by the remote detection sensor 4.

It is possible, for example, to send a signal to the user interface to alert the user to an irregularity detected by the remote detection sensor 4, where this irregularity can be, for example, an aberration relating to the position, to the distance, to the luminosity, to the integrity, etc, of the document.

It is possible, in particular, to determine the distance of the document and/or of various points of a surface of the document. It is possible, in particular, to determine the conformation and/or the arrangement of the document in space.

It is possible, in particular, to determine the tilt and/or the curvature of the document or portions of the document. It is possible, in particular, to detect possible irregularities in the integrity of the document, for example if the document is torn, perforated, cut, crumpled, rippled, wrinkled, etc.

It is possible, in particular, to determine whether the document has not been placed correctly, for example too far from or too near to the image sensors 3. It is possible, in particular, to detect a situation of poor lighting of the environment and/or of the document to be read.

The measurement of the return electromagnetic radiation (in particular of the return time and/or intensity of the radiation) that has interacted with the surfaces of the document and/or of the hand of the user (placed at a distance from the remote detection sensor 4) enables qualitative and quantitative information to be obtained on the environment and surfaces. This information will be used by the electronic controller CPU to check and/or interpret and thus correct the actual reading of the document performed by the image sensor/s 3.

The remote detection sensor 4 can determine the conformation and/or the arrangement of the document (comprising creases, folds, wrinkles, tilts, tears, areas of shadow and other possible irregularities present on the document) at the moment in which the document is read by the image sensor/s 3, so as to permit a suitable correction, by the electronic controller CPU, of the reading of the document performed by the image sensor/s 3.

The remote detection sensor 4 can be configured, in particular, to determine three-dimensional space mapping of the shape of the document T at the moment in which the document T is subjected to reading by the aforesaid one or more image sensors 3.

The remote detection sensor 4 can operate, as said, by measuring the time elapsed between the emission of the pulse and the reception of the back-scattered signal. The remote detection sensor 4 can operate, alternatively or additionally, by measuring the intensity of the received back-scattered signal, in particular by measuring the various intensities of the signals received by the various receivers.

1. A reading device, comprising:
a reading zone configured to receive a document to be read, in particular a document positioned by a user;
one or more image sensors configured to read the document positioned in said reading zone;
a remote detection sensor configured to detect the document positioned in said reading zone;
wherein an electronic controller is configured to correct a reading performed by said one or more image sensors based on the detection performed by said remote detection sensor.

2. The device according to claim 1, wherein said one or more image sensors comprise two or more image sensors.

3. The device according to claim 1, wherein said remote detection sensor comprises at least one signal emitter and at least two or more receivers of a return signal arranged in different positions from each other.

4. The device according to claim 1, wherein said remote detection sensor an is configured to detect a situation of poor lighting of the environment and/or of the document to be read.

5. The device according to claim 1, wherein said electronic controller is configured to correct the reading of the document performed by said one or more image sensors based on the intensity of a return electromagnetic radiation detected by said remote detection sensor.

6. The device according to claim 1, wherein said electronic controller is configured to use information received by said remote detection sensor to recognize possible aberrations in the document and thus correct the reading of the document image performed by said one or more image sensors.

7. The device according to claim 1, wherein said remote detection sensor is configured: to detect a geometric conformation of the document positioned in said reading zone.

8. The device according to claim 1, wherein said remote detection sensor comprises: optical sensor and/or means for emitting at least one laser pulse and for receiving at least one return signal and/or at least one LiDaR sensor.

9. The device according to claim 1, wherein said one or more image sensors comprise one or more CCD sensors and/or one or more CMOS sensors and/or one or more active pixel sensors.

10. The device according to claim 1, comprising a user interface connected to said electronic controller, said electronic controller being configured to send signals to said user interface based on the detection performed by said remote detection sensor.

11. A reading method implemented by means of a reading device having a reading zone configured to receive a document to be read, in particular a document positioned by a user;
one or more image sensors configured to read the document positioned in said reading zone;
a remote detection sensor configured to detect the document positioned in said reading zone;
wherein an electronic controller is configured to correct a reading performed by said one or more image sensors bases on the detection performed by said remote detection sensor, said reading method comprising the steps of:
positioning a document in a reading zone;
reading the document positioned in said reading zone by means of one or more image sensors;
detecting a geometry of the document positioned in said reading zone while it is being read by said one or more image sensors, by means of remote detection sensor;
verifying and/or correcting the reading performed by means of said one or more image sensors on the basis of the detection performed by means of said remote detection sensor.

12. The method according to claim 11, wherein said step of detecting a geometry comprises detecting an elapsed time between the emission of a pulse by said remote detection sensor and the reception of a return signal.

13. The method according to claim 11, comprising the steps of detecting a situation of poor lighting of the environment and/or of the document to be read by means of said remote detection sensor and correcting the reading performed by means of one or more image sensors based on said detecting a situation of poor lighting.

14. The method according to claim 11, comprising the steps of recognizing possible aberrations in the document based on information received by said remote detection sensor and thus, in case aberrations are present, correcting the reading of the document image performed by said one or more image sensors.

15. The method according to claim 11, comprising the steps of correcting the reading of the document performed by said one or more image sensors based on an intensity of a return radiation detected by said remote detection sensor.

16. The device according to claim 1, wherein said remote detection sensor is configured to detect the document based on a time elapsed between the emission of a pulse and the reception of a return signal.

17. The device according to claim 1, wherein said remote detection sensor is configured to detect information on the document positioned in said reading zone based on at least one intensity of a return signal received after an emission of a pulse.

18. The device according to claim 1, wherein said remote detection sensor is configured to detect information on the inclination and/or curvature of the document and/or on the three-dimensional geometry of the document.

19. The device according to claim 1, wherein said remote detection sensor is configured to detect information on the presence or absence of objects extraneous to the document such as, for example, a finger of the user.

20. The device according to claim 1, wherein said remote detection sensor is configured to determine a three-dimensional space mapping of the shape of the document positioned in said reading zone while the document itself is subjected to reading by said one or more image sensors.
